(19) United States
(12) Patent Application Publication
(10) Pub. No.: US 2008/0201338 A1
(43) Pub. Date: Aug. 21, 2008

(54) REST FOR ENTITIES

(75) Inventors: Pablo Castro, Redmond, WA (US); Alex Anthony Barnett, Redmond, WA (US); Timothy Ian Mallalieu, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/675,944

(22) Filed: Feb. 16, 2007

(51) Int. Cl. G06F 17/00

(52) U.S. Cl. 707/100

(57) ABSTRACT

The claimed subject matter provides a representational state transfer (REST) interface over a data store characterized by an entity data model (EDM) architecture. Such characterization can be presented by way of an Entity Framework that can transform data characterized in one manner at a relational database into an EDM characterization that can further be exposed to an external process or device. A REST interface over EDM stores can provide an end-to-end framework to expose data, modeled in a highly-expressive fashion, to the Internet or a web-scale intranet.

### CROSS-REFERENCE TO RELATED APPLICATIONS

This application is related to co-pending U.S. application Ser. No. ______ (MSFTP1719US), filed , entitled “LIVE ENTITIES INTERNET STORE SERVICE.” The entirety of this application is incorporated herein by reference.

### BACKGROUND

Traditional databases use a relational model for representing data stored within a data store. The relational model is a system enabling data independence, wherein the physical representation of data stored within a database is distinct from a logical view presented to a user of the database. The relational database model was introduced over 30 years ago and enjoyed great success as a means for presenting stored data in a useful format. Over time, some shortcomings did surface as the relational model was applied to newer and varying technologies (e.g., technologies spawned by the Internet). In particular, structured query language (SQL) became used nearly exclusively as a query language for relational model data stores, and a lack of sufficient adaptation caused the language to become relatively cumbersome for some modern applications. In addition, the relational model, based on mathematical relationships, was structured in a theoretical fashion as compared to later-developed object-based data models. Because of their conceptual simplicity, many application programmers preferred object-model and subsequent modeling schemes to the traditional relational model.

In recent years, much discussion has occurred in regard to how computational systems communicate, especially systems that are loosely correlated. Some discussions centered on web services and an initiative for formalizing local processes of particular web services. Some of these web services exhibited a dual application and service nature, allowing agents on the Internet to consume those services through either a consumer-ready interface or a more sophisticated application programming interface that provided direct access to data stores. For certain industries, the dual service and application configuration was a good fit. However, these configurations were relatively complex, and did not fit the needs of some consumers, particularly database, application and web site developers. Alternative architectural styles began to develop, focusing on a simple interface for applications and services to interact with data stores. One particular architecture was designed around characteristics that had made the Internet successful as a large networking entity, and was termed a representational state transfer model, or REST model.

The REST interface architecture is centered on a simple interface, which capitalizes upon various characteristics contributing to the success of the Internet. For example the REST model utilizes a server and client side cache structure that mitigates repetitive component interaction. Additionally, REST provided a stateless environment such that each interaction defined all information required to carry out that interaction. The REST model was successful partially because of this stateless environment, which did not require a component to keep track of prior interactions or communication histories with other components. It is on this REST platform, and traditional data modeling schemas such as the XML schema, that much of the current web service application programming structures have been based.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, exposes an entity data model (EDM) store by way of a stateless, uniform interface that can transport requests and results related to the EDM store. The interface can accept a query, e.g., a uniform resource identifier (URI) query, in accordance with structural relationships established by entity data modeling, and can return a query result via a simple representation format, including eXtensible Mark-up Language (XML), resource description framework (RDF), java script object notation (JSON), and the like. Accordingly, an end-to-end framework can be provided that exposes data to the Internet in a simple, uniform way, while utilizing highly expressive data modeling available via entity data modeling.

In accordance with another aspect of the claimed subject matter, a data store, such as relational database, can be mapped to an EDM schema, specifying EDM Entities and Relationships. Such EDM Entities and Relationships can be subsequently mapped to a representational state transfer (REST)-related URI space. Consequently, data stores represented by expressive EDM Entities and Relationships can be queried by way of well-recognized URI formats. Entities themselves can be exposed as resources with stable REST-related URI's, such URIs reflecting the structure and stores described by an EDM schema. Because the REST-related environment can be uniform and stateless, semantics can be straightforward and need not interfere with scalability.

In one particular aspect of the claimed subject matter, an Entity Framework (e.g., a .NET-brand Framework) can interface with a relational data store and overlay a conceptual layer atop a relational layer. More specifically, a client-side views engine associated with the Entity Framework can map a relational data model utilizing a relational schema to a potentially richer EDM data model and EDM schema. Additionally, a REST interface can be utilized to expose such a data store to a web-scale network such as the Internet, a large corporate intranet, or the like, enabling an external client to view the data store as an EDM store over such web-scale network. The Entity Framework and REST interface can conjoin a high level of data independence with scalability requirements of a vast web-space, effectuating a conceptual application programming environment over an access network much larger than what was previously available for such environment.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a high-level block diagram of a stateless, uniform interface over EDM stores in accord with an aspect of the subject innovation.

FIG. 2 is a high-level block diagram depicting an EDM schema applied to a traditional relational database in accordance with a particular aspect.

FIG. 3 is an exemplary block diagram illustrating multiple client-side interfaces in accord with the claimed subject matter.

FIG. 4 depicts an exemplary block diagram illustrating a REST interface exposing an EDM view of a relational store translated by a mapping component of an Entity Framework architecture in accord with an aspect of the subject innovation.

FIG. 5 depicts an example methodology for exposing EDM stores via a stateless, uniform interface in accord with a particular aspect.

FIG. 6 illustrates an example methodology for receiving a query at an Internet EDM store and providing a response in accord with one aspect of the claimed subject matter.

FIG. 7 illustrates an example methodology for querying an EDM store and receiving a reply via a REST interface in accord with a particular aspect of the claimed subject matter.

FIG. 8 depicts an exemplary networking environment, wherein the novel aspects of the claimed subject matter can be employed.

FIG. 9 illustrates an exemplary computing environment in accordance with the claimed subject matter.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, “entity data model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components, and can be as simple as a command line or a more complex Integrated Development Environment (IDE).

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

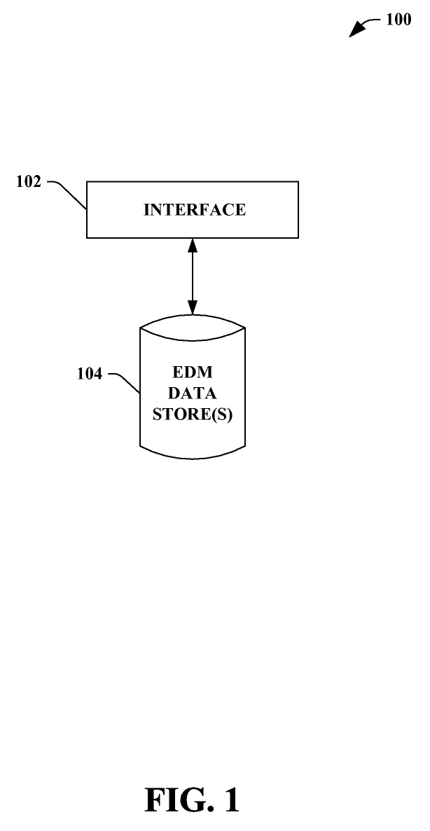

Referring now to the drawings, with reference initially to FIG. 1, a system 100 is depicted that illustrates an interface 102 over an entity data model (EDM) store(s) 104 in accord with an aspect of the subject innovation. Interface 102 can transport requests and results related to EDM store 104, and can be both stateless and uniform. As a uniform interface, interface 102 can provide a platform of information exchange such that information is transferred independent of applications requesting such information. Consequently, applications can evolve independently of each other, and representations (discussed infra) can be utilized to present information in a substantially similar format. A uniform interface to EDM data store(s) 104, therefore, can enable access thereto by way of multiple client-type components (not shown). For instance, a consumer ready user interface can be developed to utilize such a platform (e.g., a web site). In addition, an application programming interface (API) can be developed without a need for complex or proprietary protocols. Such an API interface could be utilized by programmers or developers (e.g., website developers, etc.)

As a stateless interface, interface 102 can enable storage components, e.g., EDM data store(s) 104, to retain little or no data regarding prior transactions with another entity. In other words, a request or reply between two connected systems, e.g., a client and a server, can contain all of the information necessary to understand the request or reply. For example, if a client system makes a request for information stored at a server system, that request must specify all information required by the server to complete the request. Further, subsequent requests by the client are not dependent upon prior requests; the server system retains no information regarding prior interaction with other components. Such an interface can substantially maximize availability of contemporaneous memory resources at the server, and can imply that the server system does not have to manage resource usage across various requests. Equating the server system of this example to an EDM data store, e.g., EDM data store(s) 104, a stateless interface can enable such EDM store 104 to quickly scale its response activity to meet increasing request activity. On a vast and complex network such as the Internet or a large intranet, request activity can increase rapidly, and sometimes randomly from a server perspective. Thus, scalability can be an advantageous aspect related to server performance.

EDM data store(s) 104 can be one or more virtual or physical devices that can store information and present that information externally according to an EDM data modeling scheme (e.g., by way of a mapping function that can present a relational schema as an EDM schema). The EDM can be a formal way of modeling data that explicitly defines an Entity. EDM can further use more highly expressive constructs for such definition, e.g., concepts such as inheritance and relationships, to model data at an appropriate and particular level of abstraction. Traditionally, data stores use relational models to describe a structure of data. In contrast, EDM can create a tiered architecture that enables description of data at a higher level of abstraction. For instance, an EDM approach can be less focused on the structural details that have to do with systems and more focused on the structural and semantic characteristics of the data itself, as seen by a data modeler (e.g., web-site, database, API developers, etc.)

An EDM schema can have one or more Entity types that define the structure of Entities, where Entities are particular instances of an Entity type. For example, one Entity type could be ‘consumer’, and can include any virtual or real-world object fitting a description of ‘consumer’. An Entity related to the ‘consumer’ Entity type could be ‘Bob the consumer’. ‘Bob the consumer’ therefore can be one particular instance of the ‘consumer’ Entity type, of which many other particular instances can exist (e.g., ‘Jane the consumer’, ‘Company B’, ‘State of Washington’ etc. could all be Entities of the ‘consumer’ Entity type). Entities (instances) therefore can have a particular relationship with Entity types, and can have relationships with other aspects of the EDM as well.

Entity types can have properties associated therewith (e.g., a descriptor, quality, attribute, etc.) Properties can be utilized to describe Entity types and/or distinguish Entities of a particular type from other Entities of a particular type. Moreover, such properties can be utilized to filter one set of EDM data from another set of EDM data via a query fragment (discussed infra). Continuing the previous example, a ‘consumer’ Entity type can have properties associated therewith such as ‘name’, ‘address’, ‘phone number’, ‘e-mail’ etc. Such properties can help to form one aspect of an inheritance concept of data modeling.

In most real-world applications, entities are related to other entities in some way. The EDM can incorporate this concept via the notion of Relationships. Relationships are instances of Relationship types, analogous to Entities being instances of Entity types, and can express an association between instances of two or more Entity types (e.g., ‘Bob the consumer’ Purchased ‘Operating System’, where the Relationship instance in italics, ‘Purchased’, can express an association between two Entities, namely, ‘Bob the consumer’ and ‘Operating System’). While the concept of relationships in data modeling is not new, the existence or potential for instances of Relationships associated with Relationship types can present a new level of abstraction in regard to data modeling, over and above that previously available in a relational model.

One specific EDM relationship is the inheritance relationship, implemented in practice by full or partial property transfer from a first object (e.g., instance, type or set, or the like) to a second object. In EDM data modeling, Entity types can acquire attributes from other Entity types, enabling structural inheritance utilizing a super-type—subtype format. A subtype Entity can acquire a set or a subset of attributes (e.g., properties, described supra) belonging to a super-type, and can further be assigned additional attributes (e.g., additional properties, relationships, and the like). A second EDM relationship is the Association relationship, which can be a first-class relationship construct supported throughout the EDM modeling system. Association relationship can enable peer-to-peer modeling. The example recited supra with regard to a Relationship instance ‘purchased’, can exhibit a peer-to-peer relationship. More specifically, two Entity instances, ‘Bob the consumer’ and ‘Operating system’, each of different Entity types, namely ‘consumer’ and ‘goods’, are related via a ‘purchased’ relationship instance. Associations therefore can relate one or more independent Entity instances via a peer-to-peer format whereas Containments can relate one or more dependent Entity instances via a parent-child format. At an instance-level, Entities can be contained within a third EDM topology, an Entity-Set, specifically, an Entity set or a Relationship set correlated to an Entity type or Relationship type. For example, all ‘consumer’ instances (e.g., ‘Bob the consumer’ and all other instances of a ‘consumer’ type) associated with a ‘consumer’ Entity type can be grouped together into an Entity set.

EDM sets can contain multiple Entity instances of a particular Entity type, and consequently can be associated with an Entity type. An Entity set can be conceptualized approximately as a table (e.g., a spreadsheet table having columns and rows). Multiple Entity sets can be grouped into Entity Containers, which can be conceptualized approximately as a database.

EDM data store(s) 104 are one or more physical or virtual storage devices having data organized according to the EDM architectural style, as described supra. For example, EDM data store(s) (104) can be described by an EDM schema mapped to one or more storage components, such as a physical, logical, or relational store, or the like. Such an arrangement can allow for a highly expressive form of modeling or shaping of data. By exposing the data store by way of a stateless, uniform interface, e.g., interface 102, consumers can exploit and manipulate data without need for custom protocols or complicated interaction modeling. For example, interface 102 can facilitate identifying, querying, retrieving, and/or updating information related to EDM data store(s) 104 and/or providing an end-to-end framework for exposing highly-expressive data in a vast web environment such as the Internet, a large intranet, or the like.

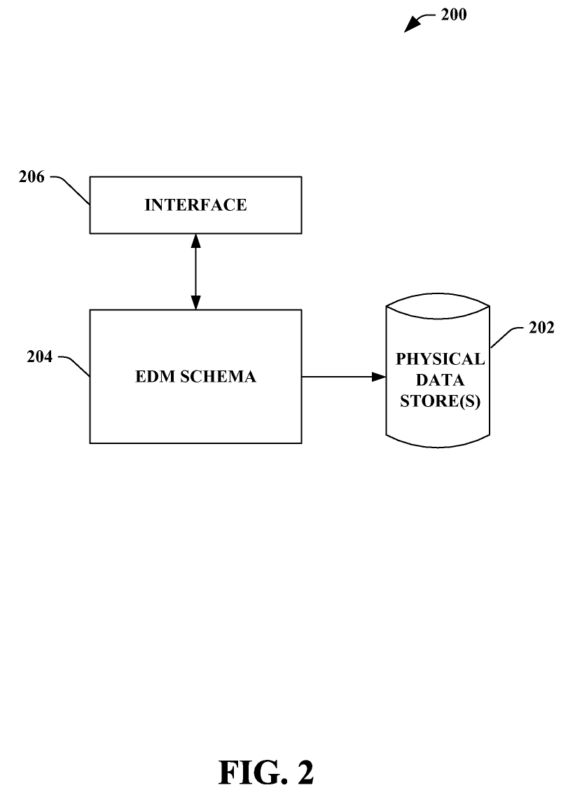

Referring now to FIG. 2, a system 200 is depicted that includes an EDM schema applied to a traditional relational database in accordance with a particular aspect of the claimed subject matter. Physical data store(s) 202 can be any type of virtual or physical data storage medium, including, for instance, hardware and/or software (e.g., threads, processes, computing devices etc.), a server, a database, and the like. EDM schema 204 can be an entity data model structure similar to that described above, that can shape and organize information according to Entity types, Entity instances, and Entity sets. Furthermore, EDM schema 204 can inter-relate Entity types, instances and sets via one or more Relationship types, instances or sets. Relationships can be Association and/or Inheritance-based relationships, which can serve to preserve peer-to-peer and/or super-type—subtype characteristics. Furthermore, such relationships can be first-class relationships allowing explicit and implicit association between entities in both directions. As an example, a first-class relationship can allow a client device (not shown) to navigate over a relationship from a first entity to a second, and then back from the second entity to the first.

Interface 206 can provide a stateless, uniform access to physical data store(s) 202 specified by EDM schema 204. Such access can enable a component (e.g., a client device) to find, obtain and/or update entities from stores on a large, web-style architecture such as the Internet or a large intranet. As discussed previously, a stateless, uniform interface can provide for scalability and can allow developers to create applications based on a simple representation of data (discussed infra). Moreover, such architecture can enable a programming environment, e.g., an Entity Framework (discussed in more detail infra), to apply a client-side views engine to formulate an EDM schema (e.g., EDM schema 204).

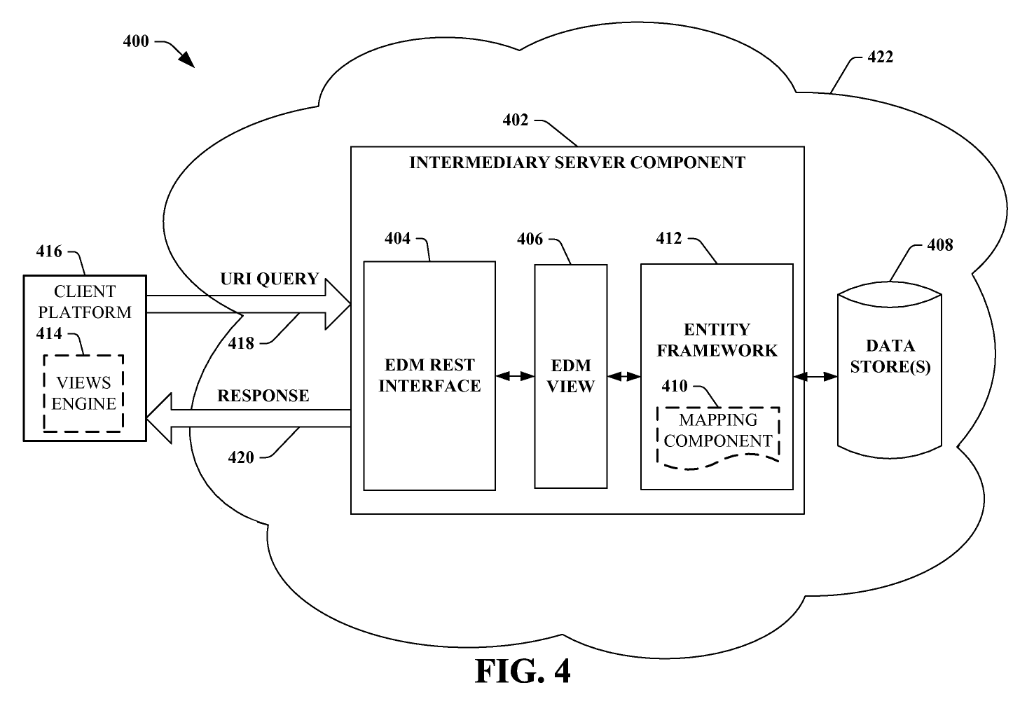

A client-side views engine can interpret a declarative mapping specification to present an interface schema (e.g., an EDM schema) at a client device different from a storage schema associated with a traditional relational store (e.g., physical data store(s) 202). (It should be appreciated therefore, that EDM data store[s 104 depicted in FIG. 1 can also be a relational database, with a mapping specification [applying, e.g., an EDM schema such as EDM schema 204] as described herein.) An Entity Framework environment and its application to such an interface is discussed in more detail infra at FIG. 4.

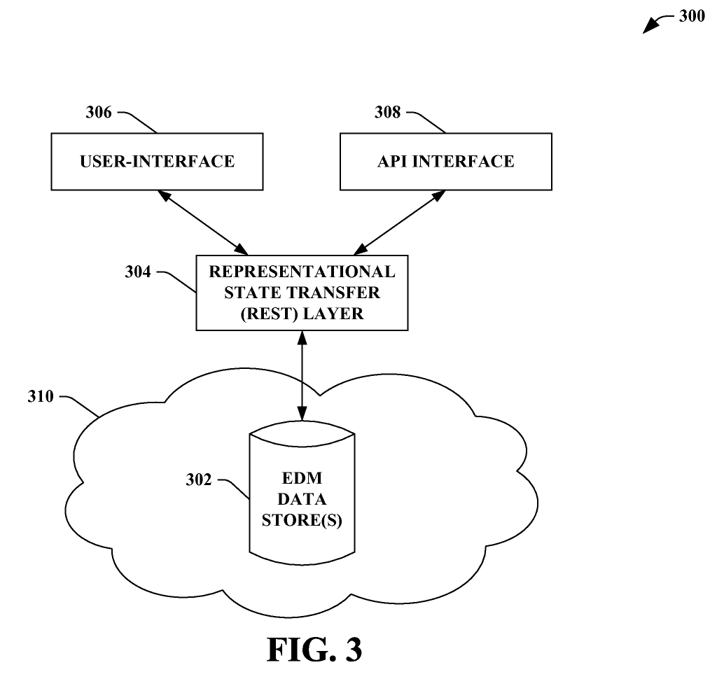

Referring now to FIG. 3, an exemplary block diagram illustrates a system 300 with multiple client-side interfaces in accord with the claimed subject matter. EDM data store(s) 302, as discussed supra, contain information characterized by an EDM structure (e.g., an EDM schema). Representational state transfer (REST) layer 304 can be a particular data interface associated with large-scale networking environments such as the Internet. The REST model can offer several device interface constraints that have proven effective with a large-scale networking environment. Examples of interface characteristics that can be associated with REST layer 304 are a stateless interaction (discussed supra) allowing for client-side demand scalability, a uniform component interface ideal for large-grain hypermedia data transfer (e.g., large data files such as video, audio, etc.), client-side and server-side cache to help alleviate resource demands resulting from repetitive requests, and a layered component architecture that places an upper bound on system complexity and promotes independence between components. It is to be appreciated that REST layer 304 can include combinations of some or all of these characteristics, as well as additional characteristics facilitating data transfer in a large-scale networking environment.

Generally speaking, REST layer 304 provides a mechanism to transport requests and results between EDM data store(s) 302 and an external interface (e.g., an external interface can include a client user-interface 306, a client-side API interface 308, etc.) More specifically, REST layer 304 can allow a client interface to find, obtain and update entities from EDM data store(s) 302 on a large web-style network 310 (e.g., the Internet, a large intranet, etc.) REST layer 304 uses a simple resource-centric model for managing requests. REST layer 304 is also stateless, as discussed supra, simplifying relational semantics and optimizing scalability of the EDM data store/REST layer interface.

The REST structure, of which at least a part defines REST layer 304, works well with EDM entities. EDM entities are exposed as resources with stable URIs. Such URIs reflect the structure of stores described by an EDM schema (e.g., EDM data store(s) 302). More specifically, access to EDM data store(s) 302 can be by way of a web-style transfer protocol (e.g., HTTP protocol, and the like) structured in the form of a URI namespace that defines resources on EDM data store(s) 302 according to an EDM schema. One example format follows:

<base URI>/<entity container refx file>[/<entityset>[/<entity
key>[/<association navigation property>]]]?<options>

The “base URI” can point to a web server/directory that can host an Entity environment (e.g., an Entity Framework, discussed in more detail infra) and REST extensions. A “refx file” represents a connection to a store/container (e.g., EDM data store(s) 302); an entity set, entity key, and navigation property are regular EDM constructs, defined in part supra. Options include representations of data, and will be discussed in more detail infra.

As an example, if a given EDM schema has an Entity type of ‘customer’, instances of which are grouped within a ‘customer’ Entity set, the following URI can list all of the customers contained within this Entity set (which can define a subset or set of a data store contained within EDM data store(s) 302):
http://entities.live.com/refx/northwind.refx/Customers
   Additionally, it is possible to navigate further into the EDM structure and identify a particular customer instance contained within a customer Entity set, by utilizing an entity key associated with that particular customer instance. To continue the previous example, if an entity key for a customer instance is “ALFKI”, a URI that can navigate to a resource associated with the customer instance can be:
http://entities.live.com/refx/northwind.refx/Customers/ALFKI
   or, as an alternative example,
http://entities.live.com/refx/northwind/refx/Customers/[ALFKI].
   Such an alternative can allow for data lookup functions utilizing non-key fields, for example:
http://entities.live.com/refx/northwind.refx/Customers[CompanyName=“Company_One”].

EDM data store(s) 302 can have relationships (e.g., Relationship Entity, Relationship instance, Relationship Set, and the like) described by an EDM schema associated therewith and exposed through REST layer 304. Continuing the previous example, Entity type ‘customer’ has a navigation property ‘SalesOrders’ related thereto and defined as part of the EDM schema. The navigation property can represent a relationship between a given customer and its sales orders, for instance. A URI that can represent such sales orders related to the Entity type ‘customer’ can appear as follows:
http://entities.live.com/refx/northwind.refx/Customers/ALFKI/SalesOrders
   or, alternatively:
http://entities.live.com/refx/northwind.refx/Customers[ALFKI]/SalesOrders

The URIs illustrated in the ongoing example are stable pointers to entities in a web-style network 310, making such URIs useful, for instance, in conjunction with a transient application or with long term storage, or both. To further illustrate, a URI that points to an Entity (e.g., an instance of the ‘customer’ Entity type) can contain, or be used in conjunction with, a ‘GET’ HTTP command to obtain a copy of the Entity. Moreover, a URI can contain, or be used in conjunction with, a ‘PUT’ or ‘POST’ command to insert, or update, an Entity within a data store (e.g., the instance of the ‘customer’ Entity type, specified above, contained within EDM data store(s) 302).

Advanced Entity types, sets, and instances can be represented by EDM data store(s) 302 as well, including action sets that extend current methods of EDM data modeling. Actions could be expressed in EDM terms, for instance, by referring to entities in EDM schemas, and can be mapped to actual implementations analogous to the manner in which EDM schemas are mapped to relational and/or physical stores (e.g., at FIG. 4 infra as well). EDM Action instances can be exposed by a stateless, uniform interface (e.g., interface 102 supra, or REST interface 304), but represent actions instead of resources. For example, when interacting with a customer resource, such as ‘customer’ Entity type, the following URI was presented:
http://entities.live.com/refx/northwind.refx/CustomersALFKI (or [ALFKI])
   An action analogy, such as ‘start marketing campaign’ could take a customer category as a parameter, and invoked, as an example, by the following URI:
http://entities.live.com/refx/northwind.refx/Actions/StartCampaign?customers Category=/Categories/SMB

In addition a general purpose synchronization infrastructure can be integrated naturally into an Entity concept as presented. With such an infrastructure in place, applications built on top of a REST interface 304 and EDM data store 302 (e.g., as part of or in conjunction with user-interface 306) could not only access information across a web-scale network, but also synchronize it with local data stores (e.g., an SQL-type server management schema) effectively providing an off-line operation mode similar to some e-mail and communication applications. Going beyond traditional client-server replication, such a synchronization infrastructure could support peer-to-peer replication. Such replication enables the creation of applications that have multiple peers carrying EDM stores with entities, forming a ‘mesh-store’ that is convergent as systems synchronize over time.

In addition to the replication system mentioned above, compatibility with a new version of simple sharing extensions (SSE) can enable interoperable synchronization across agents that can operate in SSE terms. Utilizing SSE extensions system 300 could be able to provide feeds of changes of an entity store (e.g., entity data store(s) 302) consumable by SSE-aware clients and analogous applications.

Referring now to FIG. 4, a system 400 is illustrated that depicts an intermediary server component 402 that can provide an EDM REST interface 404 for exposing an EDM characterization (view) 406 of a data store(s) 408. A modeling schema associated with data store(s) 408 can be translated from a relational data model to an EDM model by way of a mapping component 410 associated with Entity Framework 412. Entity Framework 412 is a programming architecture that can raise a level of abstraction utilized in data programming. Additionally, Entity Framework 412 can incorporate the EDM architecture, can provide relational to EDM mapping (e.g., via mapping component 410), and can incorporate a language-integrated query (LINQ) (not shown) system.

Several characteristics can typically be associated with Entity Framework 412 in the context of mapping a relational schema to an EDM view 406. First, EDM view 406 presents a data model wherein artificial constructs are not required to navigate through Entities. More specifically, EDM view 406 does not specify peculiarities outside of the EDM structure necessary to access data store resources, in contrast to traditional relational databases. Second, although the Entity framework 412 code can be database intensive, no database connection objects exist, no external language (e.g., SQL for query formulation) is necessary, and no parameter binding is necessary, etc. Consequently, Entity framework 412 can eliminate extra interactions typically required for data-centric applications, and also can introduce a new level of data independence by separating a database schema (e.g., a traditional relational database schema) from a view of data that is appropriate for a given application or service. Mapping component 410 can effectuate this data independence by way of a mapping specification that can transform data presented in a relational model to an EDM model as discussed above. Such transformation allows, for instance, data modelers and developers to map from a relational schema to a richer EDM schema and subsequently present a shape of data different from an actual database schema and defined by the EDM structure.

For example, a ‘customer’ Entity set, can contain instances of Entity type ‘customer’. A table, for instance, can represent the Entity set having instances of the Entity type ‘customer’ contained in columns and/or rows of the table. Alternatively such table can be converted to 2 tables each having vertically partitioned data, columns of which could be a subset of columns in the original, traditional database, and can, for instance, have different names. Moreover, an EDM schema defining ‘SalesOrders’ can be included as a column in such a table. Traditionally, a relational database does not have a relational instance that can point to sales orders pertaining to a customer instance, so such a construct would have to be provided by a declarative mapping specification that can provide an EDM schema, such as provided by mapping component 410 and/or Entity Framework 412.

EDM view 406 can specify EDM structures for data within data store(s) 408 utilizing an entity model (e.g., Entity types, instances, and sets as discussed supra) a relationship model (e.g., Relationship types, instances, and sets also discussed supra) and/or advanced Entity types, such as an action type Entity (e.g., an action can be expressed in EDM terms and relate to Entity nouns in EDM schemas, and be mapped to implementations within data stores. A situation such as “start marketing campaign” could define a parameter related to an Entity action, such as a ‘customer’ Entity, and correlate the ‘customer’ Entity, the ‘action’ Entity, and some result Entities, for example invoking budget constraints or a target audience related to the ‘start marketing campaign’ action. Moreover, such an action could be invoked via a REST-based query or URI as describe supra). EDM REST interface 404 can support URI queries 418 to interface with data store(s) 408, in addition to LINQ queries (e.g., LINQ to Entities), discussed above. A response 420 returned to client platform 416 can typically utilize a representation format with which to specify the data queried. In addition, because Entities are represented by particular representation formats on the Internet, URI query 420 can also include representation format query languages. Some examples include RQL and SPARQL, both RDF based representation query languages. Alternatively, query fragments associated with Entity Framework 412 can be utilized within URI query 418. As an example, a query requesting all Entity instances associated with an Entity type ‘customer’ can be further filtered via a query fragment. A query can apply a filter specifying “apply the filter “it.State=‘wa’” to modify a ‘customer’ Entity query to return only instances of an Entity type ‘customer’ having a state ‘Washington’ associated therewith.

Views engine 414 is a powerful client-side engine that can interpret data from a rich, conceptual EDM schema (e.g., EDM view 406) and display it at a client platform 416. More specifically, client platform 416 can utilize a REST-based URI query 418 (or other query format, for example where query information is incorporated into a payload of a request/response interaction) language to interface with an EDM view 406 of a data store(s) 408. A REST-based query enables a client to interface with EDM view 406 over a web-scale network 422, such as the Internet or a large intranet, because of the scalability and uniformity inherent in the REST architecture, as discussed supra. Results of a query can be expressed to a client as if the underlying database were a rich EDM store as opposed to physical or logical stores.

A REST-style interface (e.g., EDM REST interface 404) generally specifies mechanisms for interaction with data stores and referencing resources, but doesn't specify information about a format of the data queried. Instead, a response can utilize entity representation formats to specify a data structure as it appears to client platform 416 (displayed by views engine 414, for instance). Examples of representation formats include ATOM, rich site summary (RSS), resource description framework (RDF), and java script object notation (JSON), and plain old XML (POX).

The POX format refers to a simple, ad-hoc data format having no particular specification to adhere to. In such a format, a request for an entity results in a simple XML document in response. Referring back to examples provided in conjunction with FIG. 3, the URI specifying an Entity instance ‘ALFKI’ such as:
http://entities.live.com/refx/northwind.refx/Customers/ALFKI (or alternatively
http://entities.live.com/refx/northwind.refx/Customers/[ALFKI])
   can produce an XML result, if a POX entity representation format is utilized, appearing substantially similar to the following:

```
(1.)<Customer>
  (2.)<CustomerID>ALFKI</CustomerID>
  (3.)<CompanyName>Alfreds Futterkiste</CompanyName>
  (4.)<ContactName>Maria Anders</ContactName>
  (5.)<City>Berlin</City>
  (6.)<Country>Germany</Country>
  (7.)<SalesOrders href=”Customers/ALFKI/SalesOrders” />
(8.)</Customer>
```

No schemas, namespaces, or other structure other than that needed to represent the data provided by the response is included within a POX entity representation format. For example, the values provided at lines 2 through 6 include only properties (supra) associated with an Entity type (e.g., ‘customer’), such as the company name (Alfreds Futterkiste) and city (Berlin) associated with the Entity instance (ALFKI), for instance. The value presented at line 7, SalesOrders, is not a property of an Entity type, but instead is a navigation property (discussed supra) that represents a Relationship (e.g., a relationship specifying an association with the sales orders associated with this customer).

The POX format illustrated in the previous example can be a default response format for requests against data store(s) 410 of system 400. A format expected by such system 400 can further be indicated simply by using a standard ‘Accept’ HTTP header. The HTTP header format allows separation of an address or identifier of an Entity from any particular representation. Such separation allows customization of a URI according particular requirements. In addition, note that a data representation format can be specified within a URI. If a responseType option specifies an ‘Accept’ multi-purpose internet mail extension (MIME) type of ‘text/xml’ (which could also be ‘*/*’), POX representation format will be used for data represenation. If HTTP headers cannot be customized, or are otherwise insufficient, use of a query string parameter can be supported by system 400.

If a URI query 418 is associated with an ‘Accept’ MIME type specifying ‘application/rdf+xml’, response 420 will utilize an RDF representational format to represent transmitted data. RDF is an existing representation protocol preferred by some sectors of private industry (e.g., entities interested in Web 2.0 and Semantic Web). RDF is also a highly expressive format and handles relationships between resources well, which fits well with a system exposing relationships via URI requests (such as system 400). The URI request presented in the previous example
http://entities.live.com/refx/northwind.refx/Customers/ALFKI?responseType=application/rdf+xml
   can provide an RDF representation format at client platform 416 substantially similar to:

```
  <rdf:RDF xml:base=http://entities.live.com/refx/northwind.rfx
      Xmlns:rdf=”http://www.w3.org/1999/02/22-rdf-syntax-ns#>
    <Customer rdf:about=”Customers/ALFKI”>
        <CustomerID>ALFKI</CustomerID>
        (3.)<CompanyName>Alfreds
Futterkiste</CompanyName>
        (4.)<ContactName>Maria Anders</ContactName>
        (5.)<City>Berlin</City>
        (6.)<Country>Germany</Country>
        (7.)<SalesOrders
rdf:resource=”Customers/ALFKI/SalesOrders”/>
    </Customer)
  </rdf:RDF>
```

Such result is similar to the example results provided by the POX format, supra, and can be minimally invasive when utilizing compact encoding. The result presented in this RDF example also represents a ‘customer’ Entity instance. Further, it contains information related to a source of a query (e.g., the “xml:base” element in the root element) and relationship instances, also expressed as RDF resources (e.g., the rdf:resource attribute of the SalesOrder element). An RDF processor (not shown) can, given this customer, explore its orders by simply composing a new URI out of the “base” and the “resource” pointers for a particular RDF property.

Another example representation format for data delivered to client platform 416 via response 420 is a JSON format. An ‘Accept’ MIME type specifying “text/javascript”, “text/json” or “application/json”, or combinations thereof, will produce a JSON format for replied data. JSON can give client-agents (e.g., client platform 416, web browsers, and the like) substantially instant support for presenting data as objects. Tools such as ASP.NET Ajax (atlas) can build upon the JSON format.

Continuing the previous example, utilizing an ‘Accept’ MIME header of “text/json” within the example URI:
http://entities.live.com/refx/northwind.refx/Customers/ALFKI?responseType=text/json
   can provide a data format substantially similar to the following:

```
  {
    ‘_base’: ‘http://entities.live.com/refx/northwind.refx’,
    ‘_about’: ‘Customers/ALFKI’,
    ‘CustomerID’: ‘ALFKI’,
    ‘CompanyName’: ‘Alfreds Futterkiste’,
    ‘ContactName’: ‘Maria Anders’,
    ‘City’: ‘Berlin’
    ‘Country’: ‘Germany’
    ‘SalesOrders’: { ‘_resource’: ‘Customers/ALFKI/SalesOrders’
}
  };
```

It should be appreciated that other representation formats aside from JSON, POX, and RDF can be to provide a format for returned data in accord with various aspects of the claimed subject matter.

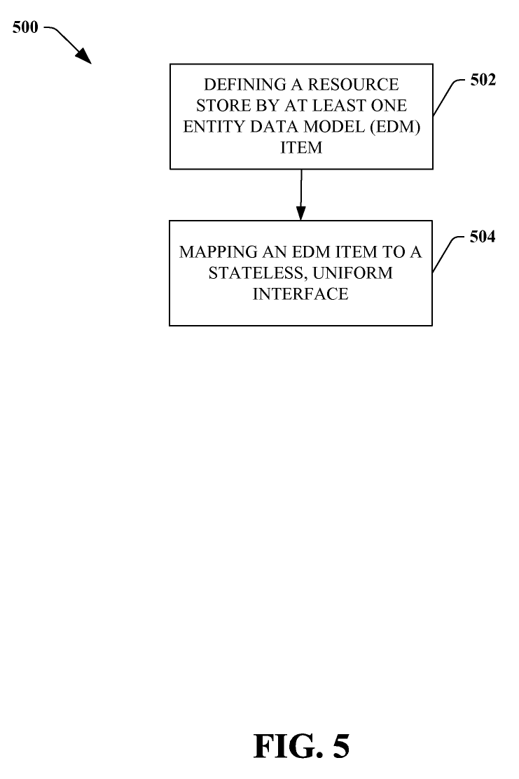

Referring now to FIG. 5, an example methodology for exposing EDM stores via a stateless, uniform interface is depicted in accord with a particular aspect of the subject innovation. At reference number 502, a resource store is defined by at least one entity data model (EDM) item. The resource store can be any suitable physical or virtual storage device including, e.g., a server. An EDM item can be, for example, an Entity type, an Entity instance, an Entity set, or combination thereof. Furthermore, the EDM item can include a Relationship type, a relationship instance, or a relationship set providing a characterization of an Entity type, instance, or set, or interrelating two or more Entity types, instances, or sets, for example. In accord with methodology 500, an Entity set can be represented in a substantially similar fashion to a table containing specific Entity instances. Additionally, Entity sets or Relationship sets can be grouped into an Entity container related to such set, or combinations of such sets. Whereas an Entity set can be represented in a substantially similar fashion as a table, an Entity container can be represented in a substantially similar fashion as a database. It should be appreciated that correlations between EDM items and data stores described supra in connection with systems disclosed herein are applicable to the methods described herein as well, including methodology 500 at reference number 502.

At reference number 504, a stateless, uniform interface is mapped to the at least one EDM item. Such an interface exposes information related to an EDM item and/or a resource store, and transports queries and replies related to a resource store. The interface transfers data independently of applications requesting such data. Such an interface fosters independent application growth and can support data representation formats that display data contained in a resource store. Furthermore, the interface enables stateless interactions between a resource store and other components. It follows therefore, that storage components need not retain data regarding prior transactions with other components. Stateless interaction therefore can be important in providing network scalability required by vast, web-style networks, including the Internet and a large intranet. Consequently, methodology 500 can allow data, modeled in a highly expressive manner on a resource store, to be exposed to the Internet and meet scalability requirements while providing application independence; characteristics required for success in such an environment.

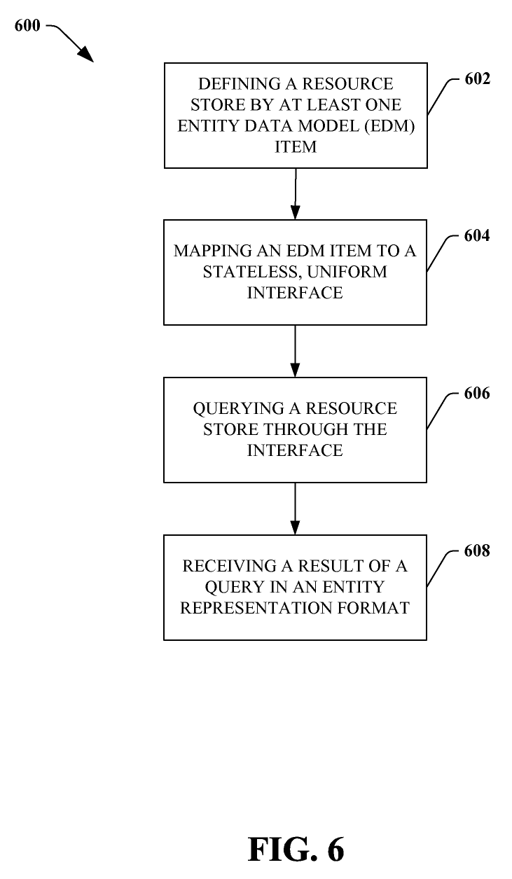

Referring now to FIG. 6, a methodology is depicted for querying and receiving data, modeled in a highly expressive manner via an EDM structure, from a data store on the Internet. At reference number 602, a resource store, and/or data contained therein, is defined by at least one EDM item. As described supra, the EDM item can explicitly define a virtual or real-world entity, using highly-expressive constructs for such definition, and further equate that definition to a resource store. The EDM item can create a tiered architecture enabling description of data or resource store at a higher level of abstraction than conventional relational models. At 604, the at least one EDM item is mapped to a stateless, uniform interface. Such interface provides a mechanism for sending queries and responses to queries to and from the resource store. The stateless, uniform interaction provides for scalability and application independence making vast web-style networks such as the Internet successful entities. Consequently, a resource store can be exposed via the Internet when mapped to an interface as specified.

At reference number 606, a query is transported to the resource store via the interface. Such query can contain all information required to adequately respond thereto. The query can be structured in accord with an EDM schema representing the EDM item. For example, the query can be based on a URI format expressing the EDM structure as illustrated supra. Furthermore, the query can be in a LINQ format sufficient for distinguishing EDM modeled resource stores. Moreover, the query can be in a representation format query language, such as RQL or SPARQL. Such a language can be appropriate since Entities modeled on Internet stores can be described in representation formats.

An EDM query as specified above can enable the resource store can locate data corresponding to a particular EDM entity or relationship state utilizing only the query itself At reference number 608, a result of a query is received via the interface with data contained therein expressed in an Entity representation format. Such representation format can adequately describe data contained within one or more resource stores. Examples of representation formats in accord with various aspects of methodology 600 include JSON, RDF, and POX. Other formats can include ATOM and RSS, although most any suitable format for representing EDM structured data at a device are appropriate within the context of methodology 600.

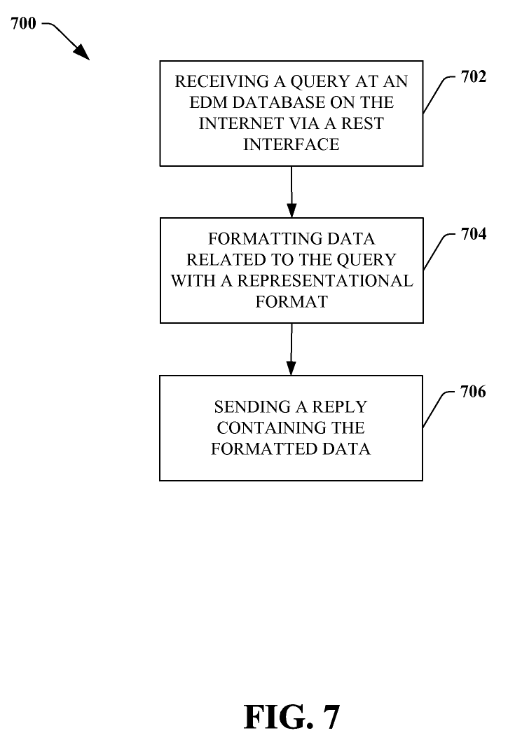

With reference now to FIG. 7, a methodology is illustrated for receiving and responding to a query at a data store on the Internet, modeled according to an EDM structure, via a REST interface. At 702, a query is received at an Internet EDM modeled database via a REST interface. The REST model offers several device interface constraints that have proven effective with a large-scale networking environment. Several examples of such constraints are listed as follows. First, REST offers a stateless interaction that relieves network components of having to retain information related to prior data transfer operations. This allows component resources to be quickly cleared and increases network scalability. Second, a uniform component interface provides for large-grain hypermedia data transfer (e.g., streaming video, audio, voice over internet protocol IP, and the like). Third, client-side and server-side cache can help alleviate resource demands resulting from repetitive requests. And fourth, a layered component architecture that places an upper bound on system complexity and promotes independence between components.

The REST model has been very successful for database interaction in large-scale networking environments such as the Internet; however, traditionally there had been no end-to-end frameworks for exposing highly-expressive, modeled data to the Internet in a simple and uniform way. Pairing a REST interface with an EDM modeling approach can provide such a framework. A query to an Internet database, as specified at reference number 702, can utilize a simple format associated with the EDM architecture, including, e.g., a URI mapped to an EDM structure, specifying Entity type, instance, and/or sets, properties, etc. as described herein, a LINQ query language, or a data representation format query language, specified supra. Note that such a query will typically point to a resource store represented by an Entity instance, set, container, type, or like EDM construct. It is possible for no data to be contained within such store, although such a query is still valid and a reply can still be sent indicating the lack of data in such a resource store.

At 704, data related to the query, stored in one or more relational database stores is formatted according to a representation format. Generally, a REST architecture does not specify how data itself should be formatted. Independent formats can specify such, including JSON, RDF, and POX, for instance. At 706, a reply is sent via the REST interface containing the formatted data.

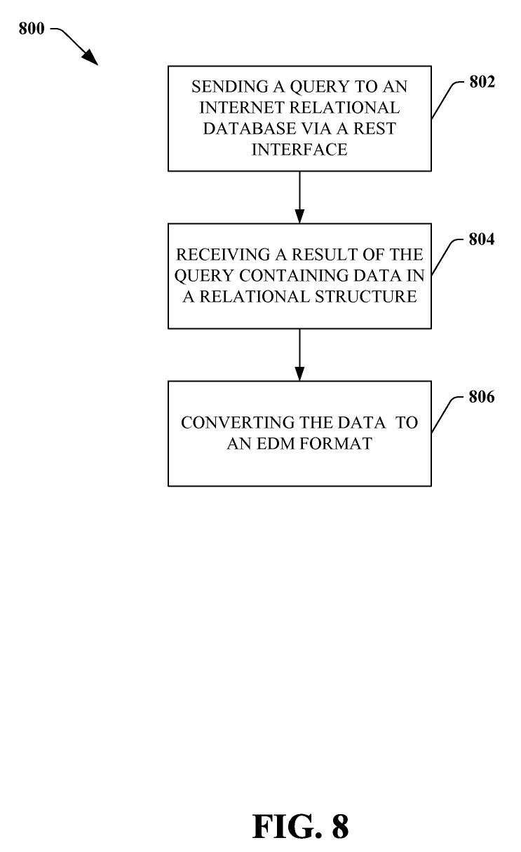

Referring now to FIG. 8, a methodology 800 is depicted for interacting with a relational database and converting relational data stored thereon to a richer, EDM format at a client device. At 802, a query is sent to an internet relational database via a REST interface (described supra). The query can be of any standard format known in the art for accessing relational databases. In addition, the query can also be of a format utilized within a Entity Framework architecture described herein, such as a LINQ query, a URI mapped to a relational database structure, etc. At 804, a result of a query is received containing data in a relational structure. At 806, the data is structured into a richer, EDM format at a client device and can optionally be displayed as such thereon. Such conversion can be performed by a client-side views engine (e.g., associated with an Entity Framework, discussed supra) utilizing a declarative mapping specification. A declarative mapping specification in accordance with methodology 800 can allow data to be presented in a shape different from the specified by a relational database structure. More specifically, web developers and data modelers can present data in a richer EDM structure at a client component.

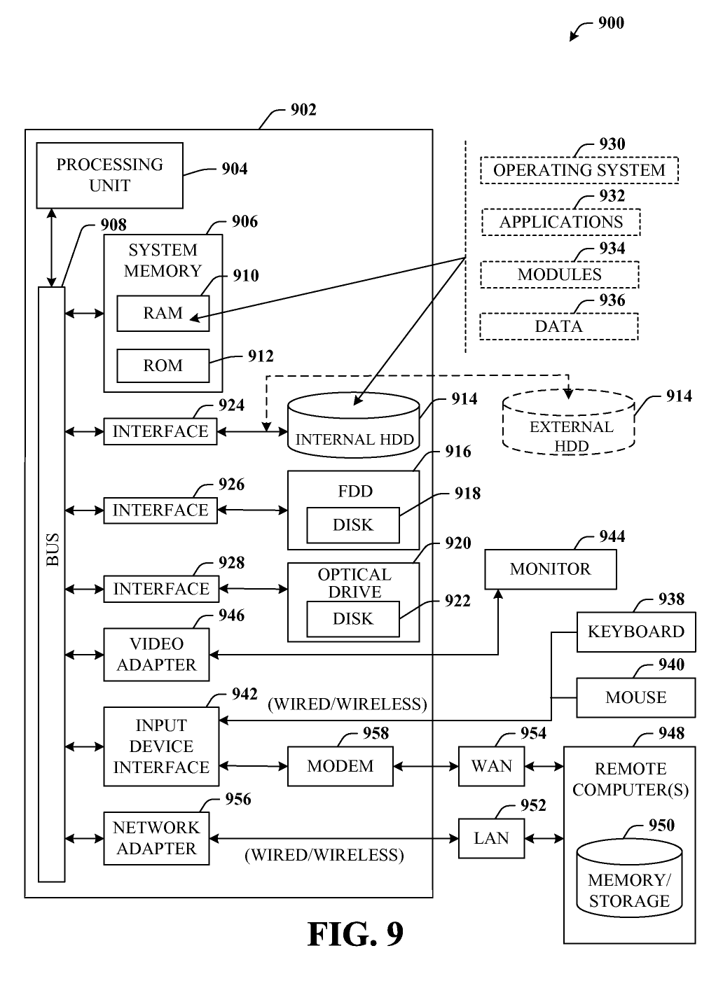

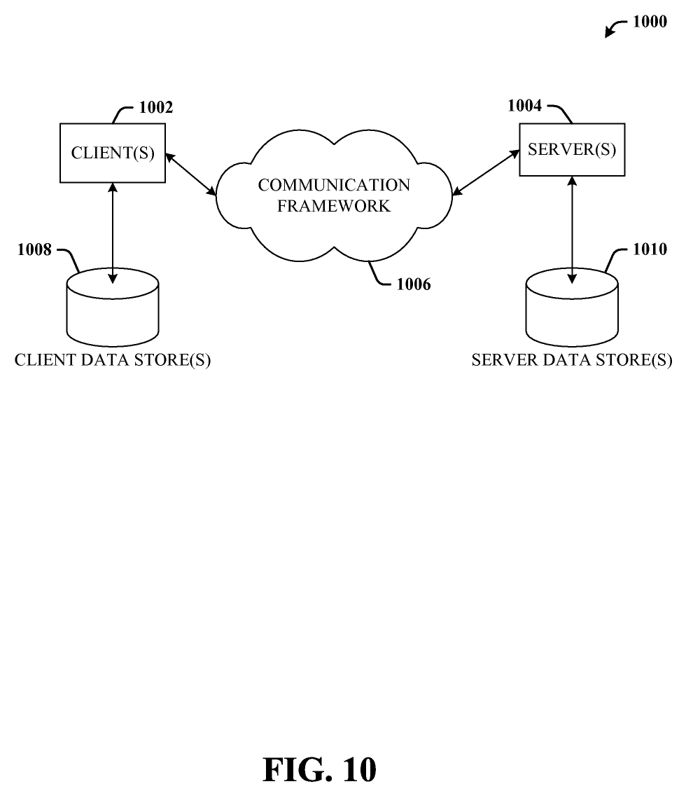

Referring now to FIG. 9, there is illustrated a block diagram of an exemplary computer system operable to execute the disclosed architecture. In order to provide additional context for various aspects of the subject invention, FIG. 9 and the following discussion are intended to provide a brief, general description of a suitable computing environment 900 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the invention includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject invention.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the invention can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g., the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 9BaseT wired Ethernet networks used in many offices.

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the invention, for example.

The system 1000 also includes one or more server(s) 1004. The server(s) 1004 can also be hardware and/or software (e.g., threads, processes, computing devices). The servers 1004 can house threads to perform transformations by employing the invention, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates access to an entity data model (EDM) store, comprising:
an entity data model (EDM) store; and
a stateless, uniform interface that transports requests and results related to the EDM store.

2. The system of claim 1, the EDM store is described by an EDM schema mapped to one or more logical, or physical, or both, storage components.

3. The system of claim 1, the requests and results related to the EDM store further comprise at least one of identification, access, update, or retrieval interaction, or combinations thereof, with the EDM store to expose information related to or contained within, or both, the EDM store.

4. The system of claim 2, the EDM schema further comprises a formalization of at least one of an Entity type, an Entity instance, or an Entity set, or a Relationship type, Relationship instance, or a Relationship set, or an Action type, an Action instance, or an Action set, or combinations thereof.

5. The system of claim 4, the EDM schema further comprises a formalization of at least one of a Relationship type, a Relationship instance, or a Relationship set, or combinations thereof, to provide a real-world context for the at least one of an Entity type, an Entity instance or an Entity set or combinations thereof.

6. The system of claim 1, the stateless, uniform interface is a representational state transfer (REST) interface.

7. The system of claim 1, the identification, access, update, or retrieval interaction further comprises a uniform resource indicator (URI) in accord with the EDM schema.

8. The system of claim 1, further comprising at least one EDM entity representational format exposed through the stateless, uniform interface that preserves semantics of EDM constructs.

9. The system of claim 8, semantics of EDM constructs include relationships and inheritance.

10. A method for providing information relating to an EDM store, comprising:
explicitly defining a resource store characterized by at least one EDM item; and
mapping at least one EDM item to a stateless, uniform interface for transporting requests and results relating to the resource store.

11. The method of claim 10, the EDM item further comprising an EDM entity, an EDM relationship, or a combination of an EDM entity and an EDM relationship.

12. The method of claim 10, further comprising querying the resource store through the uniform, stateless interface.

13. The method of claim 10, further comprising receiving a result of a query in an EDM entity representation format.

14. The method of claim 13, further comprising relating the EDM entity to at least one additional EDM entity by way of the EDM relationship.

15. The method of claim 14, further comprising preserving at least an association, or an inheritance, or both, of the EDM entity related to the at least one additional EDM entity, by way of the EDM relationship, via the one or more EDM representation formats.

16. The method of claim 13, the EDM entity representational format is one of plain old XML (POX), resource description framework (RDF), rich site summary (RSS), or java script object notation (JSON), or combinations thereof.

17. A system that provides access to an EDM store through a stateless, uniform interface comprising:
means for characterizing data that maps an EDM schema to a data store; and
means for mapping an interface to a data store that overlays the EDM schema with a stateless, uniform URI interface.

18. The system of claim 17, the stateless, uniform URI interface is a REST URI interface.

19. The system of claim 17, further comprising a querying means that queries the data store in accordance with the EDM schema.

20. The system of claim 19, further comprising a representation means that responds to a query from the querying means with data specified in an EDM data representation format.
